(19) United States
(12) Patent Application Publication
(10) Pub. No.: US 2009/0138918 A1
(43) Pub. Date: May 28, 2009

(54) APPARATUS AND METHOD FOR DISPLAYING IMAGE

(76) Inventor: Guen-Sang Bae, Seoul (KR)

Correspondence Address: BIRCH STEWART KOLASCH & BIRCH, PO BOX 747, FALLS CHURCH, VA, 22040-0747, US

(21) Appl. No.: 12/300,624

(22) PCT Filed: May 18, 2007
(86) PCT No.: PCT/KR2007/002440

§ 371 Date: Nov. 12, 2008

(30) Foreign Application Priority Data
May 24, 2006 (KR) 10 2006 0046747

(51) Int. Cl. G06F 3/00; H04N 7/173

(52) U.S. Cl. 725/56; 725/105

(57) ABSTRACT

A channel that a user is authorized to view, and channel that a user is not authorized to view are divided from each other and displayed in a channel map.

### TECHNICAL FIELD

The present invention relates to a channel map configuration of an apparatus for displaying an image.

### BACKGROUND ART

In general, an OpenCable reception device includes a host and a point of deployment (POD) module. The host refers to a set-top box that receives and processes a cable signal, or a digital cable ready (DCR) TV that may provide functions of both a set-top box and a TV. The POD module refers to a processing module that receives and decodes contents encoded at a headend.

### DISCLOSURE OF INVENTION

### Technical Problem

Since a user views a desired channel using a channel map provided from a related art OpenCable reception device, the channel map must be configured to increase convenience of a user.

### Technical Solution

In one aspect of the present invention, an apparatus for displaying an image includes a tuner receiving a broadcasting signal; an out-of-band (OOB) processor processing OOB data of the received broadcasting signal; a digital cable ready (DCR) processor separating system information from the OOB data transmitted from the OOB processor, and outputting the system information; a controller determining an active channel and an inactive channel on the basis of the system information separated by the DCR processor, and forming a channel map by separating the active channel and inactive channel from each other in the channel map; an on-screen display (OSD) generator generating an OSD to display the channel map formed under control of the controller; and an image processor displaying the OSD generated by the OSD generator.

### ADVANTAGEOUS EFFECTS

Kinds of channels and channel ratings of channels provided by a cable provider are determined on the basis of received system information to determine whether a user (i.e., subscriber or viewer) is authorized to watch each of the channels, and the channels are classified as clear and block channels according to the determination result. Then, the clear and block channels are mapped in different areas of a channel map, and such a channel map is provided to a user.

### BRIEF DESCRIPTION OF THE DRAWINGS

FIG. 1 is a block diagram for describing an apparatus for displaying an image according to an embodiment of the present invention;

FIG. 2 illustrates a channel map according to an embodiment of the present invention; and

FIG. 3 is a flowchart for describing a method for displaying an image according to an embodiment of the present invention.

### MODE FOR THE INVENTION

Embodiments of the present invention will now be described with reference to accompanying drawings.

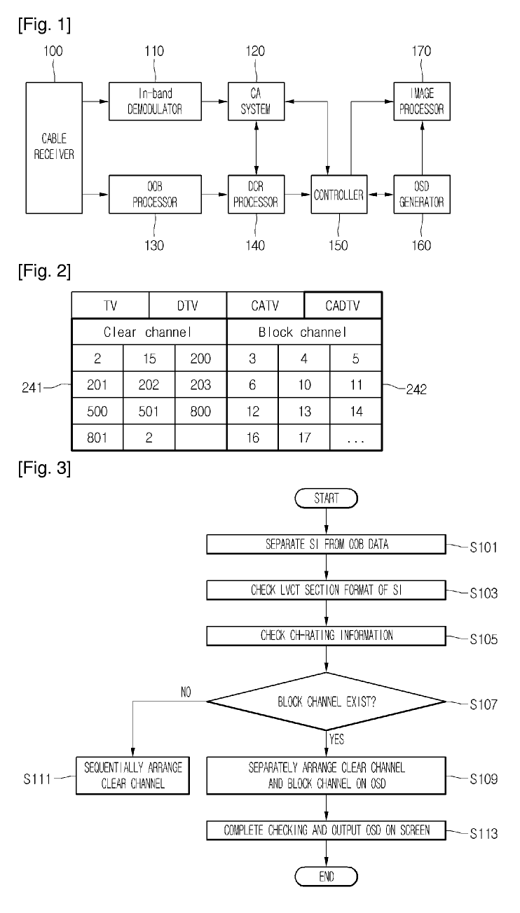

FIG. 1 is a block diagram illustrating a configuration of an apparatus for displaying an image according to an embodiment of the present invention.

Referring to FIG. 1, the apparatus for displaying an image according to an embodiment of the present invention includes a cable receiver 100 receiving a cable signal, an in-band demodulator 110 demodulating an in-band (INB) signal of the cable signal, and a conditional access (CA) system 120 controlling authority to use a cable TV service.

When a signal demodulated by the in-band demodulator 110 is scrambled, the CA system 120 descrambles the signal, and interacts with a digital cable ready (DCR) processor 140 to read information such as CA information from out-of-band (OOB) data.

The cable receiver 110 may includes an INB tuner, an OOB tuner, an OOB forward data channel (FDC) demodulator, and an OOB reverse data channel (RDC) modulator. The INB tuner performs tuning to receive a signal with a frequency of a forward application transport (FAT) channel, namely, a signal in an in-band frequency band, from an radio frequency (RF) signal transmitted from a cable headend through a cable network. The in-band demodulator 110 processes a signal output from the INB tuner, demodulates a signal using 65-Quadrature amplitude modulation (QAM) or 256-QAM, and outputs the demodulated signal.

The OOB tuner tunes a signal transmitted through an OOB FDC channel to receive a signal carrying OOB data. The OOB data is a control/access message to be transmitted to the DCR processor 140, and may include information such as CA information for controlling authority to use a cable TV service, system information (SI), electronic program guide (EPG) information, and emergency alert system information (EAS).

The OOB FDC demodulator receives a signal output by the OOB tuner, and demodulates the received signal to output the OOB data.

When upstream transmission is made from an apparatus for displaying an image to a multiple (cable) system operator (MSO) via a headend through an reverse data channel (RDC), the OOB RDC demodulator modulates data to be transmitted to the DCR processor 140.

Referring to FIG. 1 according to an embodiment of the present invention, an OOB processor 130 is illustrated as a configuration for processing the OOB data. The OOB processor 130 serves to demodulate OOB data received by the cable receiver 100, and may be considered as a combination of both the OOB FDC demodulator and the OOB RDC demodulator.

The apparatus for displaying an image according to an embodiment of the present invention includes a DCR processor 140 separating system information (SI) from the demodulated OOB data and outputting the SI, a controller 150 determining a channel that a user is authorized to view (hereinafter, referred to as an ‘authorized channel’) and a channel that a user is not authorized to view (hereinafter, referred to as an “unauthorized channel”) on the basis of the SI separated by the DCR processor 140, and thus serving to form a channel map in which the authorized and unauthorized channels are divided in different areas, an OSD generator 160 generating an on-screen display (OSD) under control of the controller 150, and an image processor 170 receiving an output of the OSD generator 160, and processing data such that the output is displayed on a display module.

In detail, the controller 150 determines an active channel (or clear channel) and an inactive channel (or block channel) on the basis of the SI separated by the DCR processor 140, and serves to form a channel map by separately mapping the determined active channel and inactive channel in the channel map. The inactive channel is a block channel that a user is not authorized to watch, and may be a scrambled channel, a conditional access (CA) channel, a content protection channel, or an rating-level restricted channel.

The active channel is a clear channel which is not scrambled, and is one that a user is authorized to watch.

Particularly, the controller 150 parses channel map information with respect to the SI separated by DCR processor 140, and stores the channel map information in a pre-determined memory. The controller 150 classifies channels being tuned as active and inactive channels, using information included in a long-form virtual channel table (LVCT) section of the SI.

The information may be, for example, a reserved space within the LVCT. Ch_rating_information is added to the reserved space, so that information of a clear channel, a CA channel, and a CP channel is included therein.

In an embodiment of the present invention, the clear channel which a user does not need to pay for, and the CA and CP channels that a user can watch only after paying a certain amount of money are used as examples of channels classified by a cable provider. The CA channel and the CP channel can be distinguished from each other depending on the amount of money that a user pays.

The controller 150 forms a channel map with respect to such various channels, so that a user can easily determine authorized channels. According to the embodiment of the present invention, information of the authorized channels due to complete payment of a user must be included in the SI.

In detail, the SI including information of the inactive channel may be one of a short form virtual channel table (SVCT), a long form virtual channel table (LVCT), a rating region table (RRT), a master guide table (MGT), a network information table (NIT), an entitlement manage message (EMM), and an entitlement control message (ECM). As an example of the SI, an LVCT section format will be schematically described.

<Long-form Virtual Channel Table section format>

Longform_virtual_channel_table_section( ){
Table id,
.....
Num_channels_in_section
For(i=0 ; i<num_channels_in_section ; i++){
Short_name,
.....
Major_channel_number,
Minor_channel_number,
.....
Reserved(Ch_rating_information),
.....}
.....
}

Here, the Ch_rating_information may include information of the clear channel, the CA channel, and the CP channel. The clear channel may be represented by 00, the CA channel may be represented by 01, the CP channel may be represented by 10. Thus, in this case, only 2 bits of data capacity for each channel are needed.

The controller 150 can identify authorized channels from the SI of the OOB data, and controls the OSD generator 160 to generate an OSD allowing a user to easily identify a clear channel and a block channel.

The controller 150 displays an unauthorized channel, such as a CA channel and a CP channel that a user is authorized to watch only when a user pays a predetermined amount of money, as a block channel through the OSD. Also, when the user selects the CP channel (i.e., when the user pays a predetermined money for the channel), the controller 150 classifies the corresponding CP channel as a clear channel.

Accordingly, the controller 150 can determine a kind and rating of each channel by examining the LVCT section format from the DCR processor 140, and allows a user to easily identify a block channel through the OSD.

The controller 150 detects whether there is a change in channel information received from the DCR processor 140, and updates a channel map when the channel information change is detected, so that a user can identify a block channel in real time.

FIG. 2 illustrates an OSD generated by the OSD generator 160 under control of the controller 150, and this will now be described with reference to FIG. 2.

As illustrated in FIG. 2, among tuned channels, authorized channels are arranged in a clear channel area 241, and unauthorized channels due to non-payment are arranged in a block channel area 242.

That is, in an OSD generated by the OSD generator 160, channels including broadcasting signals are not simply sequentially arranged, but are classified into authorized channels and unauthurized channels. Accordingly, the user can easily identify the unauthorized channel even if the corresponding channel includes a broadcasting signal.

A method for displaying an image according to an embodiment of the present invention will now be described with reference to a flowchart of FIG. 3.

SI (system information) is separated from demodulated OOB data in operation S101. Then, a long-form virtual channel table (LVCT) section format within the SI is checked in operation S103.

Thereafter, Ch_rating information is checked in the LVCT section format in operation S105, and it is determined in operation S107 whether each of channels including a broadcasting signal is a clear channel or a block channel.

That is, 2-bit data is included in the Ch_rating information in order to indicate whether each of tuned channels is an authorized channel based on completion of additional payment.

Data included in the Ch_rating information is read to determine whether each corresponding channel is a block channel such as a CA channel or a CP channel for which a user does not pay.

When it is determined that the tuned broadcasting channel is a block channel that the user is not authorized to watch, that is, the unauthorized channel, the clear channel and the block channel are separately arranged on an OSD in operation S109, so that the user does not have to check whether a channel is a block channel or not.

When a user is authorized to view all of channels provided by a cable provider, no block channel exists. In this case, tuned clear channels are sequentially arranged on an OSD in operation S111.

When there is a Block channel such as a CA channel or a CP channel, Clear and Block channels are separately arranged on an OSD, and the OSD is output on a screen through an image processor in operation S 13.

According to an embodiment of the present invention, kinds of channels that are provided by a cable provider, and channel ratings are determined on the basis of system information of the channels to determine whether a user (i.e., subscriber, or viewer) is authorized to watch the corresponding channels, and the channels are classified into clear and block channels according to the determination result. Then, the clear and block channels are mapped in different areas of a channel map, and such a channel map is provided to a user.

### INDUSTRIAL APPLICABILITY

The present invention has industrial applicability in that authorized channels and unauthorized channels are arranged in different areas of a channel map.

1. An apparatus for displaying an image comprising:
a tuner receiving a broadcasting signal;
an OOB (out-of-band) processor processing OOB data of the received broadcasting signal;
a DCR (digital cable ready) processor separating system information from the OOB data transmitted from the OOB processor, and outputting the system information;
a controller determining an active channel and an inactive channel from the system information separated by the DCR processor, and forming a channel map by separating the active channel and inactive channel from each other in the channel map;
an OSD (on-screen display) generator generating an OSD to display a channel map formed under control of the controller; and
an image processor displaying the OSD generated by the OSD generator.

2. The apparatus according to claim 1, further comprising:
an in-band demodulator demodulating an INB (in-band) signal of a cable signal received through the tuner; and
a CA (conditional access system) controlling authority to use a cable TV service.

3. The apparatus according to claim 1, wherein the controller detects whether there is a change in channel information received from the DCR processor, and updates a channel map when the change information change is detected.

4. The apparatus according to claim 1, wherein the controller performs control such that the active channel and the inactive channel are divided from each other and displayed together in the channel map.

5. The apparatus according to claim 1, wherein the inactive channel is a scrambled channel, a CA (conditional access) channel, a CP (content protection channel), or a rating-level restricted channel.

6. The apparatus according to claim 1, wherein the active channel is a clear channel that is not scrambled.

7. The apparatus according to claim 1, the system information is one of an SVCT (short form virtual channel table), an LVCT (long form virtual channel table), an RRT (rating region table), an MGT (master guide table), an NIT (network information table), an EMM (entitlement manage message), and an ECM (entitlement control message).

8. The apparatus according to claim 1, wherein the system information is a LVCT (long form virtual channel table), and Ch_rating_information of the LVCT includes information of one of an active channel and an inactive channel.

9. The apparatus according to claim 8, wherein the Ch_rating_information is composed of 2 bits for indicating one of the active channel and the inactive channel.

10. An apparatus for displaying an image comprising:
a tuner tuning in-band data, and OOB (out-of-band) data;
an in-band demodulator demodulating in-band data from data received through the tuner;
an OOB processor demodulating the OOB data;
a DCR (digital cable ready) processor separating system information from the OOB data and outputting the system information;
a controller determining each channel as an authorized channel and an unauthorized channel on the basis of the system information, and forming a channel map by dividing authorized and unauthorized channels in different areas of the channel map; and
an image processor displaying the channel map.

11. The apparatus according to claim 10, wherein the system information separated from the OOB data includes a VCT (virtual channel table).

12. A method for displaying an image, the method comprising:
tuning a cable channel;
extracting OOB (out-of-band) data from tuned data;
separating system information from the OOB data;
determining an active channel and an inactive channel on the basis of the separated system information;
separating the determined active channel and inactive channel from each other to form a channel map;
generating an OSD (on-screen display) to display the channel map; and
performing data processing such that the OSD can be displayed on a display module.

13. The method according to claim 12, further comprising:
detecting a change in channel information of one of the active channel and the inactive channel; and
updating the channel map when the change is detected.

14. The method according to claim 12, wherein the forming of the channel map comprises forming the channel map such that the active channel and the inactive channel are divided from each other and displayed together.

15. The method according to claim 12, wherein the inactive channel is one of a scrambled channel, a CA (conditional access) channel, a CP (content protection) channel, and a rating-level restricted channel.

16. The method according to claim 12, wherein the active channel is a clear channel that is not scrambled.

17. The method according to claim 12, wherein the system information is one of an SVCT (short form virtual channel table), an LVCT (long form virtual channel table), an RRT (rating region table), an MGT (master guide table), an NIT (network information table), an EMM (entitlement manage message), and an ECM (entitlement control message).

18. The method according to claim 12, wherein information of the inactive channel is obtained from one of an EMM (entitlement manage message) and an ECM (entitlement control message).

19. A method for displaying an image in an apparatus for displaying an image capable of receiving a digital cable broadcasting service, the method comprising:
tuning an in-band channel and an OOB (out-of-band) channel;
extracting OOB data from the tuned data, and separating system information from the OOB data;
determining whether each of channels tuned from the system information is an authorized channel or an unauthorized channel;
classifying the tuned channels as a clear channel that a user is authorized to watch or a block channel that the user is not authorized to watch according to a result of the determining, and forming a channel map by dividing the clear channel and the block channel in different areas of the channel map;
generating an OSD (on-screen display) for displaying the channel map; and
outputting the OSD through a display module.

20. The method according to claim 19, wherein the system information includes a VCT (virtual channel table).
